(19) United States
(12) Patent Application Publication
(10) Pub. No.: US 2024/0259065 A1
(43) Pub. Date: Aug. 1, 2024

(54) BEAMFORMING TECHNIQUE

(71) Applicant: Telefonaktiebolaget LM Ericsson (publ), Stockholm (SE)

(72) Inventors: Harish Venkatraman BHAT, HJÄRUP (SE); Johanna BENGTSSON, BJÄRRED (SE)

(73) Assignee: Telefonaktiebolaget LM Ericsson (publ), Stockholm (SE)

(21) Appl. No.: 18/565,659

(22) PCT Filed: Jun. 1, 2021
(86) PCT No.: PCT/EP21/64707

§ 371 Date: Nov. 30, 2023

(51) Int. Cl. H04B 7/06; H04B 7/08

(52) U.S. Cl. CPC H04B 7/0626; H04B 7/0617; H04B 7/086

(57) ABSTRACT

A technique for performing at least one of a beamformed transmission and a beamformed reception on a radio channel is described. As to a method aspect of the technique a channel estimation of the radio channel is performed, a result of the channel estimation being indicative of a channel state (1302) of the radio channel. A list of candidates (1310) is determined for a frequency domain resolution (1000) of beamforming weights, each of the candidates (1310) being associated with a loss (1312) in terms of a bit error rate, BER, depending on the channel state (1302) of the radio channel. At least one of the beamformed transmission and the beamformed reception are performed using the beamforming weights computed (1340) based on the channel state (1302) of the radio channel, wherein the frequency domain resolution (1000) for the computation (1340) of the beamforming weights is selected (1330) from the list of candidates depending on the associated loss (1312) in terms of the BER.

### TECHNICAL FIELD

The present disclosure relates to a technique for performing at least one of a beamformed transmission and a beamformed reception on a radio channel, i.e., beamforming. More specifically, and without limitation, a method and a device are provided for performing at least one of a beamformed transmission and a beamformed reception using beamforming weights computed based on a channel state.

### BACKGROUND

The Third Generation Partnership Project (3GPP) defined a Fifth Generation (5G) radio access technique (RAT), also referred to as New Radio (NR), as the next RAT to provide very high data rate along with many new services. This high data rate and more provisions for new services also brings in new complexities and challenges at both the base station and a radio device, also referred to as user equipment (UE). One of the main challenges is the ability to support very large bandwidth, e.g., 100 MHz and more per radio device.

In order to provide such large portions of the radio spectrum to individual radio devices, beamforming enables spatial diversity to densely reuse the radio spectrum.

A beamforming resolution in the frequency domain is fixed and cannot be changed in existing RATs. For example, the beamforming resolution can be selected to correspond to a width of 2 physical resource blocks (PRBs), so that all processing in the beamforming—such as weight calculation, spatial transformation, power scaling—are done every second PRB. Given the condition of the radio channel, this fixed frequency domain resolution may not always be preferable.

The document WO 2017/177 755 A1 relates to a multi-antenna system and describes adjusting the granularity of a channel estimation to be inversely proportional to a delay spread of the radio channel.

However, for the hardware requirement of the base station or the radio device, this selected resolution may still not be preferable in at least some situations. So in existing systems, either the selected resolution is much higher than actually needed by the condition of the radio channel or the hardware is not able to support the selected resolution.

### SUMMARY

Accordingly, there is a need for a beamforming technique that enables transmitters and receivers of a radio communication to control a frequency domain resolution.

As to a method aspect, a method of performing at least one of a beamformed transmission and a beamformed reception on a radio channel is provided. The method comprises or initiates a step of performing a channel estimation of the radio channel. A result of the channel estimation is indicative of a channel state of the radio channel. The method further comprises or initiates a step of determining a list of candidates for a frequency domain resolution of beamforming weights. Each of the candidates is associated with a loss in terms of a bit error rate (BER) depending on the channel state of the radio channel. The method further comprises or initiates a step of performing at least one of the beamformed transmission and the beamformed reception using the beamforming weights computed based on the channel state of the radio channel, wherein the frequency domain resolution for the computation of the beamforming weights is selected from the list of candidates depending on the associated loss in terms of the BER.

The technique may be applied to control the frequency domain resolution of the computation (i.e., the calculation) of the beamforming weights. Alternatively or in addition, the technique may be implemented for controlling a resolution (i.e., resolution selection) in the frequency domain for beamforming.

The technique may be implemented as a dynamic selection of the frequency domain resolution for computing the beamforming weights (i.e., a beamforming resolution). Alternatively or in addition, the technique may be implemented by indicating the selected frequency domain resolution for computing the beamforming weights to a communications peer, e.g., from a base station to a radio device through downlink control information (DCI).

The technique may be implemented to change the frequency domain resolution (e.g., in units of subcarriers, SCs, or physical resource blocks, PRBs) used for beamforming, i.e., a beamforming resolution. The beamforming resolution may depend on at least one of channel state (also referred to as channel requirement), hardware load, and Quality of Service (QoS). Alternatively or in addition, the technique may be implemented as an intelligent selection of the beamforming resolution based on at least one of a channel requirement of the radio channel, a QoS requirement, and hardware load of base station and/or the radio device.

The result of the channel estimation, i.e., the channel state, may be implemented by channel state information (CSI). Alternatively or in addition, the channel state may be indicative of whether the radio channel is frequency selective and/or time variant.

By selecting the frequency domain resolution from the list of candidates depending on the associated loss in terms of the BER, embodiments of the technique can be adaptive in selecting the frequency domain resolution for the computation of the beamforming weights (i.e., the beamforming resolution). Same or further embodiments can dynamically select the beamforming resolution, e.g., opposed to a statically selected beamforming resolution.

Alternatively or in addition, by selecting the frequency domain resolution from the list of candidates depending on the associated loss in terms of the BER, the selection for the beamforming may depend on a current hardware load at the transmitter or receiver (e.g., at a base station or radio device) embodying the technique. Same or further embodiments of the technique can compute the beamforming weights taking a frequency-selectivity of the radio channel and/or a QoS requirement (e.g., of the radio device) into account.

A performance degradation of an embodiment, e.g., if the radio device or the base station does not have the capacity to support a particular beamforming resolution, can be avoided, e.g., by selecting a coarser frequency domain resolution from the list of candidates. Alternatively or in addition, by using the list of candidates, a selection of an unnecessary high resolution, e.g., even though the condition of the radio channel does not require this, can be avoided.

The radio channel may be briefly referred to as channel.

The beamformed transmission and/or the beamformed reception may be briefly referred to as beamforming. The weights may also be referred to as beamforming weights or beamforming gains.

The frequency domain resolution may be briefly referred to as resolution. Since the resolution is used for the beamforming, the frequency domain resolution may also be referred to as the beamforming resolution. The inverse of the resolution (briefly: the inverse resolution) may have a unit of frequencies (e.g., kilohertz, kHz) or subcarriers or physical resource blocks (PRBs). Herein, the resolution and the inverse resolution are collectively referred to by the reference sign 1000.

The method may be performed by a transmitter on the radio channel that is performing the beamformed transmission. Alternatively or in addition, the method may be performed by a receiver on the radio channel that is performing the beamformed reception.

The channel state of the radio channel may comprise a channel response function. The channel state (e.g., the channel response function) may be indicative of how a radio signal propagates from a transmitter to a receiver on the radio channel. Alternatively or in addition, the channel state (e.g., the channel response function) may represent a combined effect of at least one of scattering, fading, and power decay with distance from the transmitter to the receiver. Alternatively or in addition, the channel response function, H(f), may be indicative of a (e.g., complex-valued) gain of the signal propagated from the transmitter to the receiver as a function of frequency, f.

The list of candidates may comprise a first candidate and a second candidate. The frequency domain resolution of the first candidate may be greater than the frequency domain resolution of the second candidate. A computational complexity for the computation of the beamforming weights may be greater for the first candidate than the second candidate. Alternatively or in addition, the loss in terms of the BER associated with the first candidate may be less than the loss in terms of the BER associated with the second candidate. Alternatively or in addition, a statistical error of the computation of the beamforming weights may be greater or less for the first candidate than the second candidate.

The beamforming weights computed with the frequency domain resolution of the second candidate may be less prone or susceptible to interference and/or noise than the beamforming weights computed with the frequency domain resolution of the second candidate, e.g., because it is based on a greater number of resource elements carrying reference signals in the frequency domain.

The least frequency domain resolution may be selected among the candidates associated with a loss in terms of the BER that is equal to or less than a predefined BER loss threshold.

The predefined BER loss threshold may correspond to and/or may depend on a quality of service (QoS) associated with data to be at least one of transmitted in the beamformed transmission and received in the beamformed reception.

The least frequency domain resolution may be selected among the candidates that are associated with a loss in terms of the BER being less than a predefined BER loss threshold and/or associated with a computational complexity being less than a predefined computational complexity threshold.

The greatest frequency domain resolution may be selected among the candidates associated with a computational complexity that is equal to or less than a computational complexity threshold.

The computational complexity threshold may depend on a current hardware load or a predicted hardware cost at a transmitter of the beamformed transmission or a receiver of the beamformed reception.

The loss in terms of the BER depending on the channel state of the radio channel may define a lower limit on the frequency domain resolution. The determination may include only candidates for the frequency domain resolution in the list that are greater than the lower limit. Alternatively or in addition, the resolution selected from the list is greater than the lower limit.

For example, the channel estimation may comprise a measurement of a coherence bandwidth and/or a measurement of a delay spread of the radio channel. The lower limit on the frequency domain resolution may be determined based on the coherence bandwidth and/or the delay spread so that the loss in terms of the BER is small, e.g., relative to the BER.

A current hardware load or a predicted hardware cost at a transmitter of the beamformed transmission or a receiver of the beamformed reception may define an upper limit on the frequency domain resolution. The determination may include only candidates for the frequency domain resolution in the list that are less than the upper limit. Alternatively or in addition, the resolution selected from the list is less than the upper limit.

The frequency domain resolution may be selected among the candidates between the upper limit and the lower limit, optionally according to a predefined BER loss threshold that corresponds to a QoS associated with data to be at least one of transmitted in the beamformed transmission and received in the beamformed reception.

Optionally, the least frequency domain resolution may be selected between the upper limit and the lower limit.

The method may be performed by a base station of a radio access network (RAN). The beamformed transmission may use a downlink on the radio channel from the base station to a radio device, or the beamformed reception may use an uplink on the radio channel from a radio device to the base station.

The base station may serve the radio device. E.g., the base station may provide to the radio device radio access to the RAN.

The base station may be the transmitter of the beamformed transmission or the receiver of the beamformed reception. Alternatively or in addition, the radio device may be the receiver of the beamformed transmission or the transmitter of the beamformed reception.

The method may be performed by a radio device connected or connectable to a base station of a RAN. The beamformed transmission may use an uplink on the radio channel to the base station serving the radio device, or the beamformed reception uses a downlink on the radio channel from the base station serving the radio device.

The radio device may be the transmitter of the beamformed transmission or the receiver of the beamformed reception. Alternatively or in addition, the base station may be the receiver of the beamformed transmission or the transmitter of the beamformed reception.

The determining of the list of candidates may comprise transmitting a control message to a receiver of the beamformed transmission or to a transmitter of the beamformed reception. The control message may be indicative of the list of candidates for the frequency domain resolution of the beamforming weights and the loss in terms of the BER associated with each of the candidates, or the control message may be indicative of the selected frequency domain resolution.

The determining of the list of candidates may comprise receiving a control message from a receiver of the beamformed transmission or from a transmitter of the beamformed reception. The control message may be indicative of the list of candidates for the frequency domain resolution of the beamforming weights and the loss in terms of the BER associated with each of the candidates, or the control message may be indicative of the selected frequency domain resolution.

The performing of at least one of the beamformed transmission and the beamformed reception may comprise transmitting a control message to a receiver of the beamformed transmission or to a transmitter of the beamformed reception. The control message may be indicative of the selected frequency domain resolution.

The control message may be downlink control information (DCI), e.g., according to the 3GPP document TS 38.212, version 16.5.0, section 7.3.1.2.2 and/or the 3GPP document TS 38.214, version 16.5.0, section 5.1.2.3. The DCI may be transmitted from the base station performing the method. Alternatively or in addition, the control message may be uplink control information (UCI). The UCI may be transmitted by the radio device performing the method.

The performing of at least one of the beamformed transmission and the beamformed reception may comprise receiving a control message from a receiver of the beamformed transmission or from a transmitter of the beamformed reception. The control message may be indicative of the selected frequency domain resolution.

The beamforming weights may be computed for frequency domain windows, respectively. A width of each of the frequency domain windows being inversely proportional to the frequency domain resolution for the computation of the beamforming weights.

The frequency domain windows may be disjoint and/or adjacent in the frequency domain.

The channel estimation may be based on reference signals that are spaced apart in the frequency domain of the radio channel. The beamforming weights may be computed for frequency domain windows based on the reference signals in the respective frequency domain window.

The method may further comprise or initiate the step of receiving (e.g., measuring) the reference signals. The reference signals may be received from a transmitter of the beamformed reception or a receiver of the beamformed transmission. In the latter case, the transmitter of the beamformed transmission may use channel reciprocity of the weights for the beamformed transmission.

Each of the reference signals may be allocated in one or more resource elements (REs).

The computation of the beamforming weights may apply an averaging filter in the frequency domain, wherein a width of the averaging filter is inversely proportional to the frequency domain resolution. The averaging filter may be a mean filter or a median filter.

The averaging filter may be applied to at least one of the received reference signals, to the result of the channel estimation (for example, to the channel state of the radio channel, optionally to the channel response function, H) computed based on the reference signals (e.g., computed for each of the reference signals separately), or to initial beamforming weights computed for each of the reference signals or computed with the highest resolution in the list of candidates.

The width of the averaging filter may correspond to a full width at half maximum (FWHM) or a halve width of the averaging filter (e.g., of an averaging distribution of the averaging filter).

The losses of the BER associated with the candidates of the frequency domain resolution in the list may be computed based on at least one of the channel state of the radio channel, a frequency correlation function of the channel state, a width of a frequency correlation function of the channel state, and a delay spread of the radio channel.

If the channel state of the radio channel corresponds to a frequency-selective channel, the loss in terms of the BER may more rapidly increase as the frequency domain resolution decreases. If the channel state of the radio channel corresponds to a frequency-independent channel (also referred to as a flat channel), the loss in terms of the BER may not or less rapidly increase as the frequency domain resolution decreases.

The inverse of the frequency domain resolution may correspond to an integer multiple of a physical resource block (PRB), optionally to an even multiple of a PRB or to a power of two of a PRB.

The inverse of the frequency domain resolution may be an integer multiple of a physical resource block (PRB), optionally an even multiple of a PRB or a (e.g., positive) integer power of two:

frequency domain resolution=1/(2^{k}·PRB),k=1,2,3,4, . . . ,

wherein the symbol PRB represents the width of one PRB in the frequency domain.

At least some method embodiments of any method aspect can select the frequency domain resolution from the list of candidates, which ensures that the data (i.e., the traffic) of the beamformed transmission and/or the beamformed reception is given the appropriate QoS treatment (e.g., the QoS of the traffic). Without limitation, for example in a 3GPP implementation, any “radio device” may be a user equipment (UE). Any radio device may be a user equipment (UE), e.g., according to a 3GPP specification.

The radio device and the base station may be wirelessly connected in an uplink (UL) and/or a downlink (DL) through a Uu interface. Alternatively or in addition, the technique may use a sidelink (SL), i.e., may enable a direct radio communication between proximal radio devices (e.g., a remote radio device and a relay radio device) using a PC5 interface. Services provided using the SL or the PC5 interface may be referred to as proximity services (ProSe). Any radio device supporting the SL may be referred to as ProSe-enabled radio device.

The radio device and/or the base station (e.g., a network node) may form, or may be part of, a radio network, e.g., according to the Third Generation Partnership Project (3GPP) or according to the standard family IEEE 802.11 (Wi-Fi). The method aspect may be performed by one or more embodiments of the base station and/or the radio device.

A radio access network (RAN) may comprise one or more base stations, e.g., performing the method aspect. Alternatively or in addition, the radio network may be a vehicular, ad hoc and/or mesh network comprising two or more radio devices, e.g., acting as the remote radio device and/or the relay radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more base stations. The radio device and the base station may be wirelessly connected or connectable (e.g., according to a radio resource control, RRC, state or active mode).

The base station may encompass any station that is configured to provide radio access to any of the one or more radio devices. The base station may also be referred to as cell, transmission and reception point (TRP), radio access node or access point (AP). The base station (and/or the relay radio device) may provide a data link to a host computer providing the user data to the radio device or gathering user data from the radio device. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a device aspect, a device according to the independent device claims is provided. The device may be configured to perform any one of the steps of the method aspect.

The device comprises processing circuitry (e.g., at least one processor and a memory). Said memory comprises instructions executable by said at least one processor whereby the device is operative to perform any one of the steps of the method aspect.

As to a still further aspect a communication system including a host computer is provided. The host computer comprises a processing circuitry configured to provide user data. The host computer further comprises a communication interface configured to forward the first and/or second data to a cellular network (e.g., the RAN and/or the base station) for transmission to a UE. A processing circuitry of the cellular network is configured to execute any one of the steps of the first and/or second method aspects. The UE comprises a radio interface and processing circuitry, which is configured to execute any one of the steps of the method aspect.

The communication system may further include the UE. Alternatively, or in addition, the cellular network may further include one or more base stations configured for radio communication with the UE and/or to provide a data link between the UE and the host computer using the method aspect.

The processing circuitry of the host computer may be configured to execute a host application, thereby providing the first and/or second data and/or any host computer functionality described herein. Alternatively, or in addition, the processing circuitry of the UE may be configured to execute a client application associated with the host application.

Any one of the devices, the UE, the base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for performing a beamformed transmission and/or a beamformed reception;

FIG. 2 shows a flowchart for a method of performing a beamformed transmission and/or a beamformed reception, which method may be implementable by the device of FIG. 1;

FIG. 3 schematically illustrates an example of a radio network comprising embodiments of the device of FIG. 1 for performing the method of FIG. 2;

FIG. 4 schematically illustrates an example of a frequency correlation of a channel state, which may be used for determining a list of candidates for a frequency domain resolution or for selecting the frequency domain resolution from the list;

FIG. 5A schematically illustrates an example of a bit error rate for different frequency domain resolutions when the radio channel has a first channel state;

FIG. 5B schematically illustrates an example of a bit error rate for different frequency domain resolutions when the radio channel has a second channel state;

FIG. 5C schematically illustrates an example of a bit error rate for different frequency domain resolutions when the radio channel has a third channel state;

FIG. 5D schematically illustrates an example of a bit error rate for different frequency domain resolutions when the radio channel has a fourth channel state;

FIG. 6 schematically illustrates an example of a relation between a width of a frequency correlation function of the channel state and the frequency domain resolution;

FIG. 7 schematically illustrates examples of resolution thresholds for the width of a frequency correlation function of the channel state to select the frequency domain resolution that is optimal for a BER loss threshold;

FIG. 8A schematically illustrates examples of a bit error rate for different fixed frequency domain resolutions when the radio channel has a fourth channel state;

FIG. 8B schematically illustrates an example of a bit error rate for a dynamically selected frequency domain resolution when the radio channel has the fourth channel state;

FIG. 9A schematically illustrates examples of a bit error rate for different fixed frequency domain resolutions when the radio channel has a fifth channel state;

FIG. 9B schematically illustrates an example of a bit error rate for a dynamically selected frequency domain resolution when the radio channel has the fifth channel state;

FIG. 10 schematically illustrates an example of a mapping of computed beamforming weights to physical resource blocks according to the selected frequency domain resolution, optionally selecting different resolutions in different regions of the frequency domain;

FIG. 11 schematically illustrates an example of a bit error rate for an adaptive frequency domain resolution as compared to a fixed high resolution wherein the adaptive resolution regards a 1% BER limit;

FIG. 12 schematically illustrates an example of a bit error rate for an adaptive frequency domain resolution as compared to a fixed high resolution wherein the adaptive resolution regards a 1% BER limit;

FIG. 13 schematically illustrates a block diagram of an embodiment of the device of FIG. 1;

FIG. 14A schematically illustrates an example of a bit error rate for different frequency domain resolutions for estimating the associated loss in terms of the bit error rate given the channel state;

FIG. 14B schematically illustrates a module for determining the loss in terms of the bit error rate;

FIG. 15 schematically illustrates a flowchart of an embodiment of the method of FIG. 2;

FIG. 16 shows a schematic block diagram of a network node embodying the device of FIG. 1;

FIG. 17 shows a schematic block diagram of a radio device embodying the device of FIG. 1;

FIG. 18 schematically illustrates an example telecommunication network connected via an intermediate network to a host computer;

FIG. 19 shows a generalized block diagram of a host computer communicating via a base station or radio device functioning as a gateway with a user equipment over a partially wireless connection; and

FIGS. 20 and 21 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

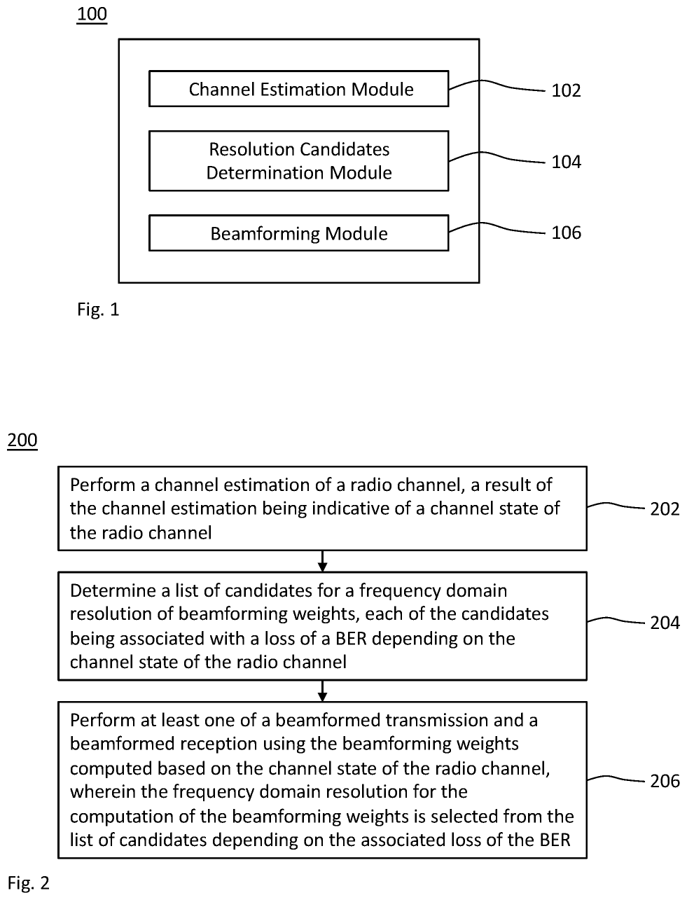

FIG. 1 schematically illustrates a block diagram of an embodiment of a device performing at least one of a beamformed transmission and a beamformed reception on a radio channel. The device is generically referred to by reference sign 100.

The device 100 comprises a modules 102, 104 and 106 as illustrated in FIG. 1 that perform the corresponding steps of the method aspect.

Any of the modules of the device 100 may be implemented by units configured to provide the corresponding functionality.

The device 100 may also be referred to as, or may be embodied by, the transmitting station (or briefly: transmitter) of the beamformed transmission and/or the receiving station (or briefly receiver) of the beamformed reception. The transmitting station 100 and the receiving station of the beamformed transmission and/or the receiving station 100 and the transmitting station of the beamformed reception may be in direct radio communication, e.g., at least for the beamforming.

FIG. 2 shows an example flowchart for a method 200 of performing the method aspect. The method comprises the steps 202, 204 and 206 as illustrated in FIG. 2.

The method 200 may be performed by the device 100. For example, the modules 102, 104 and 106 may perform the steps 202, 204 and 206, respectively.

The technique may be applied to uplink (UL), downlink (DL) or direct communications between radio devices, e.g., device-to-device (D2D) communications or sidelink (SL) communications.

Each of the transmitting station 100 and receiving station 100 may be a radio device or a base station. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR).

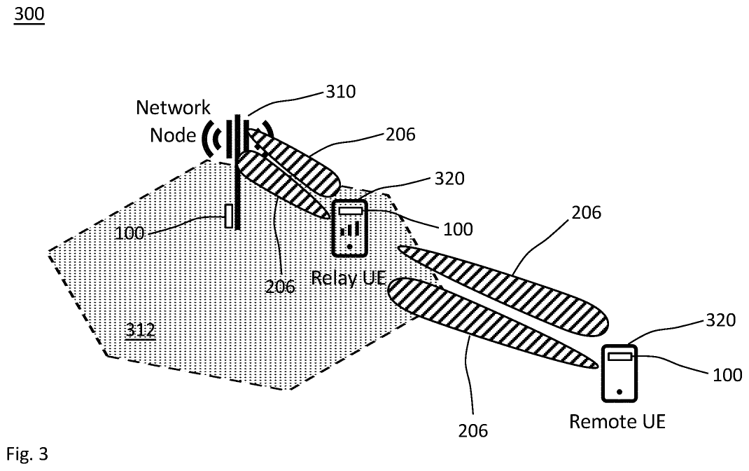

FIG. 3 schematically illustrates an example of a radio network comprising embodiments of the device 100 for performing the method 200. The radio network 300 comprises a radio access network (RAN). The RAN comprises one or more base station (e.g., network nodes) 310, at least one or each of which embodies the device 100.

Each base station 310 provides radio access to one or more radio device (e.g., UEs) 320 in a cell 312. At least one or each of the radio devices 320 (e.g., inside or outside of a cell 312 of the RAN) may embody the device 100.

The beamformed transmission 206 may use a DL from the base station 310 to the radio device 320 in the cell 312. Alternatively or in addition, the beamformed transmission 206 may use an UL from the radio device 320 in the cell 312 to the base station 310. Alternatively or in addition, the beamformed transmission 206 may use a SL between radio devices 320. A radio device 320 inside the cell 312 may function as a relay radio device (also referred to as a gateway) for a relayed radio connection between the base station 310 and radio device 320 outside of the cell 312 (also referred to as remote radio device).

The disclosure proposes a technique for dynamically adapting the beamforming resolution, i.e., the frequency domain resolution (briefly: resolution) used at least for computing the beamforming weights underlying the beamforming transmission and/or the beamforming reception. The selection of the resolution may be based on at least one of the following three requirements: the radio channel (e.g., the channel state), QoS (e.g., as required by the data to be transmitted or received or by the radio device), and hardware (HW) load of the device computing the beamforming weights (e.g., base station or the radio device).

An upper limit for the resolution may depend on the HW load. Alternatively or in addition, a lower limit for the resolution may depend of the channel requirement (e.g., the channel state). The QoS may be used to select a resolution between the upper limit and the lower limit.

The channel requirement (e.g., the channel state) may comprise at least one of the following features, e.g., a channel response function of the radio channel, channel frequency correlation function of the radio channel, a coherence bandwidth of the radio channel, and/or delay spread of the radio channel.

How much the resolution 1000 can be lowered may be determined (e.g., estimated) through analysis of the channel response function, e.g., the channel frequency response (i.e., the channel response function in the frequency domain). If the channel is very frequency-selective, a greater resolution (i.e., a finer resolution of the computed beamforming weights or smaller frequency spans of equal beamforming weights) are required to meet a BER loss threshold, e.g. to maintain a desired throughput (i.e., data rate in the step 206). If the channel is frequency-flat, the same beamforming weights can be used over a larger frequency range (i.e., a coarser resolution of the computed beamforming weights or greater frequency spans of equal beamforming weights). In the following section, the variable n represents the inverse of the resolution, e.g., in units of physical resource blocks (PRBs). A resolution of 1/(n PRB)=1/(2 PRB) is thus represented by n=2. Occasionally, 1/n PRB is written as a short-hand notation for 1/(n PRB).

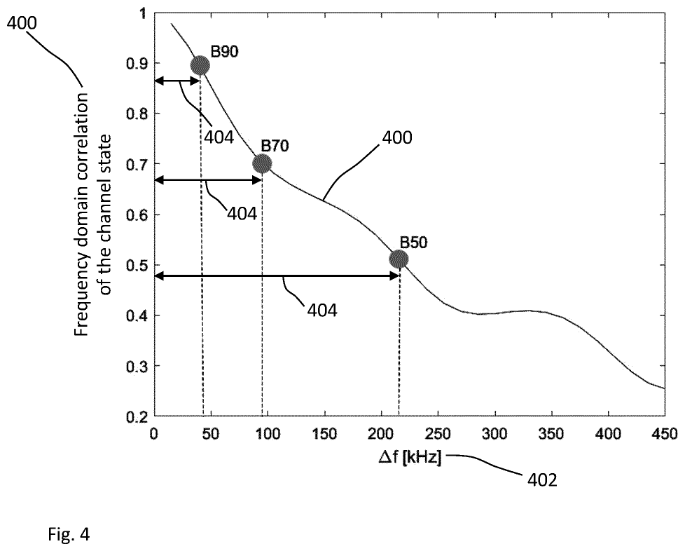

Based on the channel estimation 202, one way of analyzing or characterizing the channel state (e.g., the frequency response) is the coherence bandwidth 404 schematically illustrated in FIG. 4. The coherence bandwidth 404 may be the bandwidth over which the frequency response is nearly flat. The coherence bandwidth 404 can be determined by means of a frequency correlation function (FCF) 400,

$$FCF ( Δ f ) = E \{ H ( f ) H * ( f + Δ f ) \} ,$$

which is thus the expected value (symbolized by “E”) of the frequency response H (i.e., the channel state) at a frequency f, multiplied with the complex conjugate of the frequency response at the frequency f+Δf.

The coherence bandwidth 404 may be determined by the thresholds for the amplitude of the FCF 400, i.e., where the FCF 400 crosses a certain value. The maximum value of the FCF 400 may be 1 (e.g., by definition or normalization of the channel response function H). The thresholds for the coherence bandwidth 404 can be set to different values. Examples for the thresholds for the amplitude of the FCF 400 include the factors 0.9, 0.7, and 0.5. The width 404 (e.g., the half of the full width at the factor multiplied with the maximum) is regularly referred to as B90, B70 and B50, respectively.

FIG. 4 shows an example of a FCF 400 in the frequency domain 402 and different measures of the coherence bandwidth 404 (briefly referred to as width of the FCF 400). The values for the coherence bandwidth 404 are only example values, e.g., for a specific radio channel.

A numerical simulation of the beamforming according to NR has been used to examine how the BER (i.e., the loss in terms of the BER) depends on the coherence bandwidth 404 and resolution impact. The simulation uses a channel model “WINNER II” of the Matlab Communications Toolbox™ and minimum mean square error (MMSE) precoding for the beamforming. The simulations have been run at a carrier frequency of 2.4 GHz, a bandwidth of 20 MHz, quadrature phase shift keying (QPSK) as a modulation, and with numerology μ=0 according to 3GPP NR.

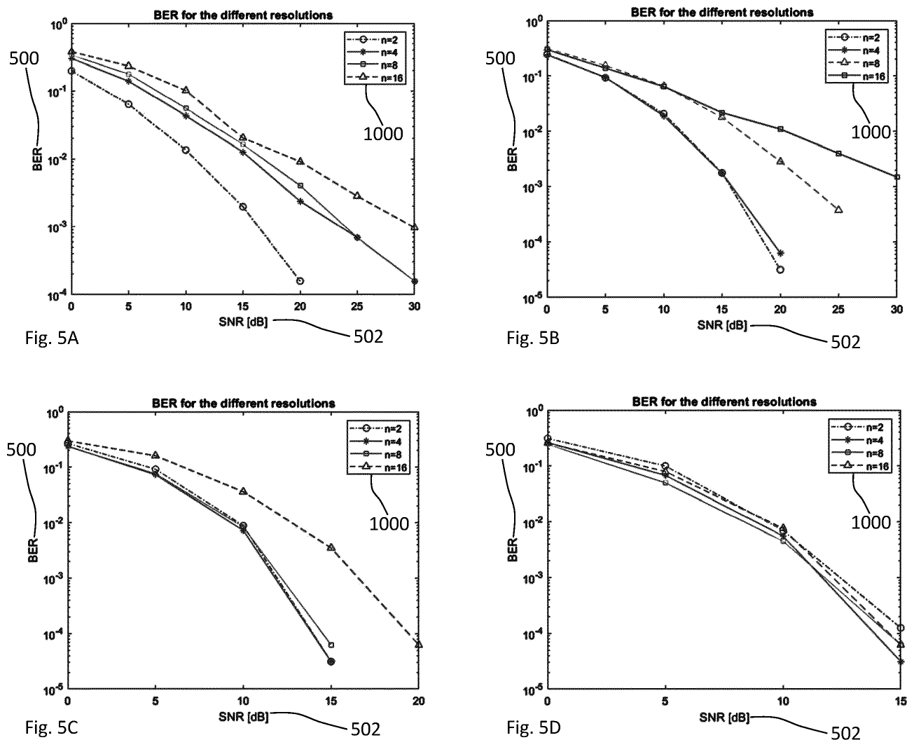

As can be seen in each of the FIGS. 5A, 5B, 5C, and 5D, the channel state (i.e., the channel condition) determines which resolution 1000 is closest to that of 1/(2 PRB). The FIGS. 5A to 5D schematically illustrates the BER 500 as a function of the SNR 502 for different candidates of the resolution under 4 different channel conditions (i.e., channel states). The candidates of the resolution 1000 is labelled using the notation 1/(n PRB).

For the first channel state illustrated in FIG. 5A, the BER 500 for all resolutions differ significantly from that of 1/(2 PRB). For the second state illustrated in FIG. 5B, the BER 500 for the resolutions 1/(2 PRB) and 1/(4 PRB) are almost aligned (i.e., equivalent). The third channel state illustrated in FIG. 5C allows selecting a resolution 1000 of 1/(8 PRB). The fourth channel state illustrated in FIG. 5D allows selecting a resolution 1000 of 1/(16 PRB).

Analogous and similar results were obtained when basing the selection of the resolution on the delay spread as another example of the channel state of the radio channel, which is inversely proportional to the coherence bandwidth.

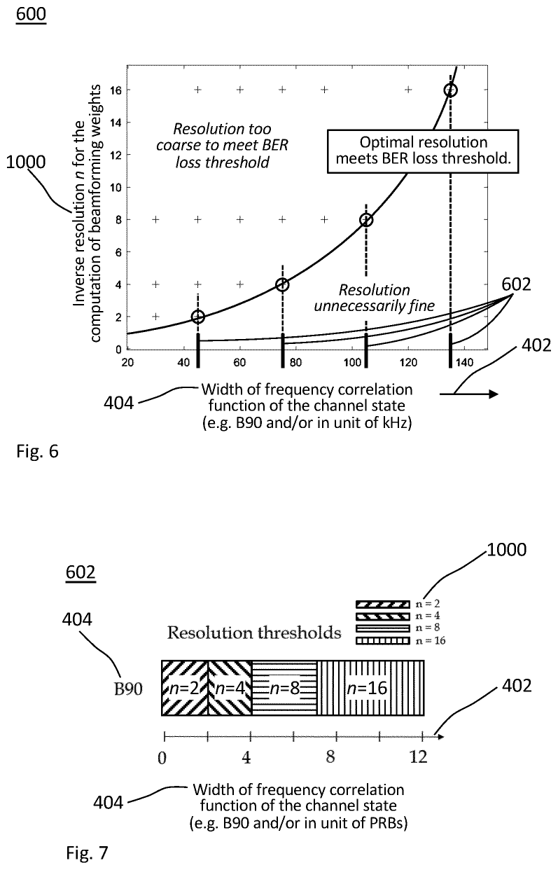

By running a simulation for different channel states (e.g., 200 different channel states), appropriate thresholds 602 for the coherence bandwidth B90 may be determined (i.e. numerically estimated). FIG. 6 schematically illustrates the relation between preferred resolutions 1000 and the width B90 404 for 200 channel states.

As shown in FIG. 6, there is a lower limit for the resolution 1000, e.g., a limit when it can be viewed as safe to choose (i.e., select) a lower resolution (i.e., greater frequency spans of equal beamforming weights) out of the list of candidates for the resolution without losing BER performance, i.e., meeting a BER loss threshold for the BER associated with the selected resolution 1000.

The thresholds for the width 404 (e.g., the coherence bandwidth and/or the FCF 400 of the channel state) may be determined by the greatest value among the samples in the 90^{th} percentile, which is illustrated by circles in FIG. 7.

FIG. 7 schematically illustrates examples of the resolution 1000 selected based thresholds 602 for the width B90 404, wherein n is the inverse resolution in number of PRBs.

Using these thresholds 602, the resolution 1000 may be selected base on the coherence bandwidth 404. The numerical simulations have revealed and established that selecting low resolutions 100 is possible while keeping the BER performance near that of a fixed resolution of 1/(2 PRB), i.e., meeting a BER loss threshold.

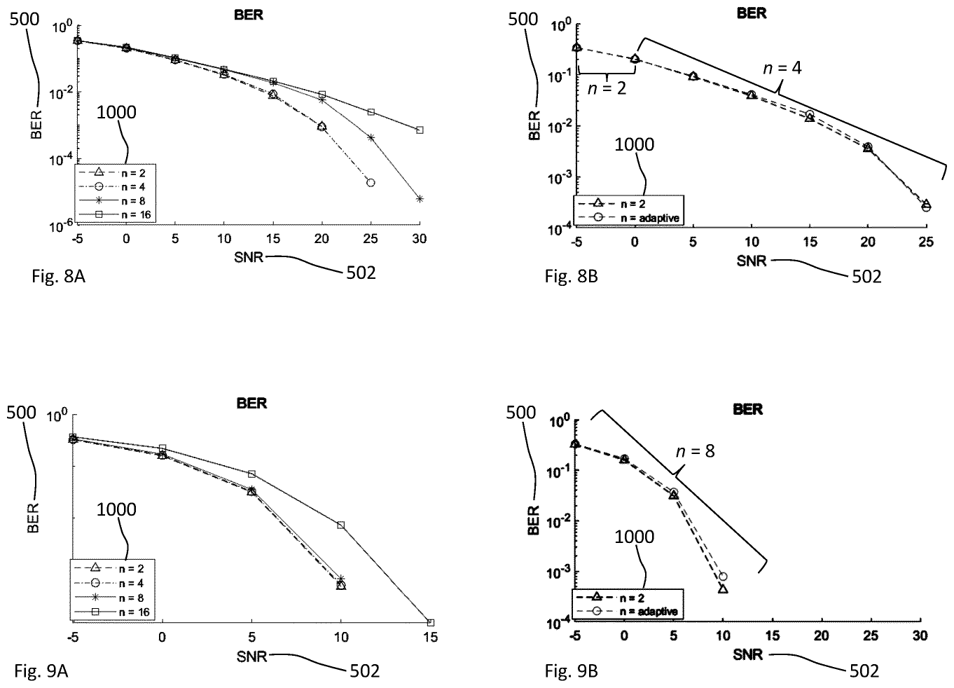

A first result of selecting the resolution 1000 is shown in FIG. 8B as compared to the resolutions fixed over the range of the SNR 502 in FIG. 8A for a first channel state. The resolution 1000 may be selected from the list of candidates according to the step 206 based on the thresholds 602 for the width 404 (e.g., the coherence bandwidth B90), i.e., depending on the associated loss of the BER 500.

A second result of selecting the resolution 1000 is shown in FIG. 9B as compared to the resolutions fixed over the range of the SNR 502 in FIG. 9A for a second channel state. The resolution 1000 may be selected from the list of candidates according to the step 206 based on the thresholds 602 for the width 404 (e.g., the coherence bandwidth B90), i.e., depending on the associated loss of the BER 500.

Alternatively or in addition, the selection in the step 206 may depend on noise (e.g., a noise level) and/or interference on the radio channel. For example, a greater resolution may be chosen at lower SNRs. To establish a relation for the selection on a noisy or interfered radio channel, the simulations have been run for 100 different channel states which on average increased the BER by 7.32%. The average of the selected resolution 1000 was 1/(6.4 PRB), meaning that the number of weight calculations performed were decreased by 69% in comparison to using a static resolution of 1/(2 PRB).

Optionally, e.g., for wider bands on the radio channel, different resolutions 1000 may be selected for different regions within the band. The FCF 400 and the correlation bandwidth 404 (e.g., B90) may be calculated individually for (e.g., smaller) the different regions in the frequency domain.

The step 204 may be performed for each of the different regions in the frequency domain. Accordingly, several resolutions 1000 may be selected in the step 206 within the band.

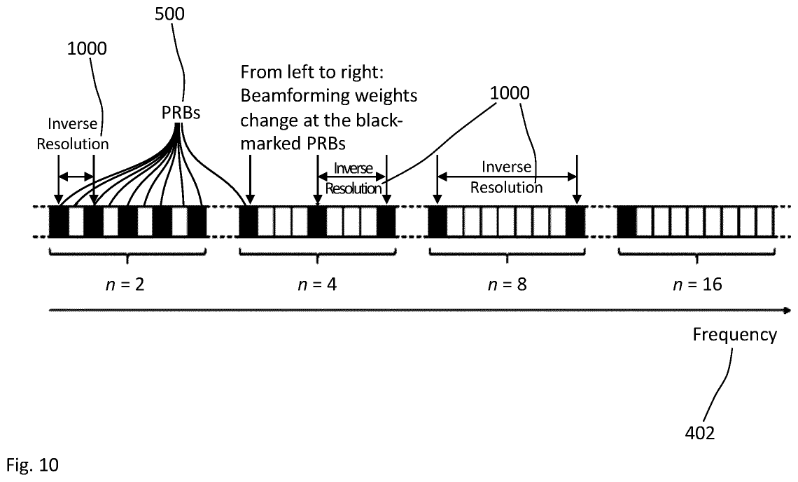

The method 200 may be implemented for a radio channel with varying coherence bandwidth 404 by fragmentation of the band. For example, a full bandwidth of 100 MHz may be divided into different regions each comprising 20 MHz. Different resolutions 1000 may be selected in each of the regions, e.g., as schematically illustrated in FIG. 10.

Using different frequency regions can increase the performance of the full bandwidth, which is particularly relevant in a real world scenario and 5G scenarios.

In any embodiment, a BER loss threshold for the loss in terms of the BER may be used in the selection of the resolution from the list of candidates according to the step 206. The BER loss threshold may be determined by a QoS requirement.

The (e.g., desired and estimated) QoS can be used to select the resolution 1000 in the step 206 to meet the QoS (e.g., in terms of the BER). The resolution 1000 may be selected between a first limit (e.g., the lower limit) set by the channel requirement (i.e., the channel state) and/or a second limit (e.g., the upper limit) set by the HW load requirement.

By using the BER as a measure for the QoS, simulations have shown that it is possible to set a BER loss threshold (i.e., a threshold for the loss in terms of the BER that depends on the QoS, also referred to as QoS-threshold) and select (e.g., adapt) the resolution 1000 according to the BER loss threshold in the step 206, and thus, according to the QoS. If the BER is less than a BER threshold (i.e., the loss is less than the BER loss threshold), a lower resolution 1000 is allowed or selected. Alternatively or in addition, if the BER is greater than the BER threshold (i.e., the loss in terms of the BER is greater than the BER loss threshold), a greater resolutions are chosen.

Herein, the loss in terms of the BER 500 may be equal to the BER 500 or may be the BER relative to the BER of a fixed resolution or a maximum resolution (e.g., 1/(2 PRB)). The BER relative to the BER of the fixed resolution or the maximum resolution may be a difference between the BER 500 and the BER of the fixed or maximum resolution or may be a logarithm of the quotient between the BER 500 and the BER of the fixed or maximum resolution.

In the following example, the BER threshold was set to 1%. Optionally, all other system parameters remain unchanged from the simulations used for the channel requirement.

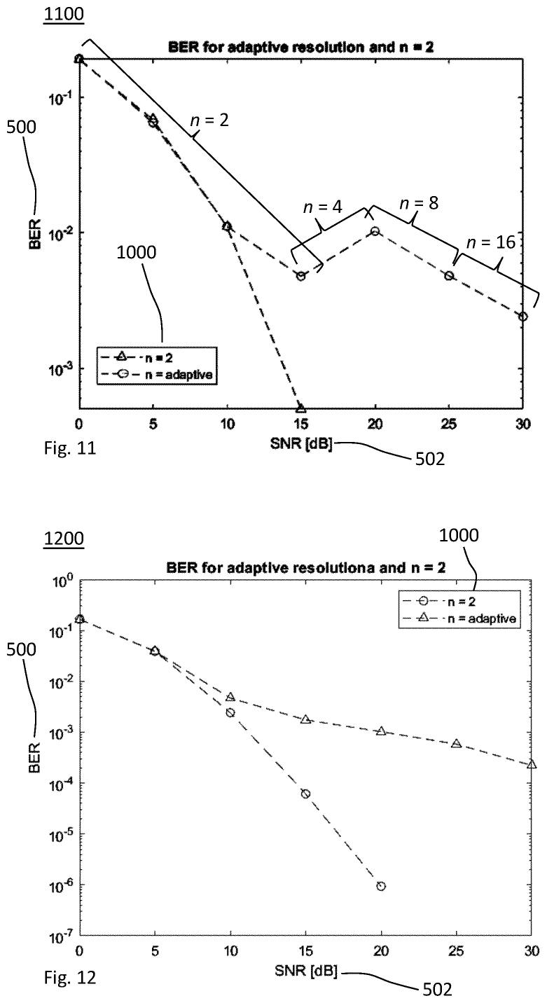

FIG. 11 shows an example of the performance of the technique, wherein the maximum resolution (e.g., 1/(2 PRB)) is selected for all SNRs if the BER 500 is greater than 1%. If a candidate for the resolution 1000 that is less than the maximum resolution results in a BER 500 that is less than 1%, then this candidate is selected instead. Consequently, in the latter case, the curve of the BER 500 does not align with the curve of the BER 500 for the maximum resolution (e.g., 1/(2 PRB)), however the resolution is lowered significantly (e.g., on average).

FIG. 12 shows the average BER using the maximum resolution (e.g., 1/(2 PRB)) compared to selecting the resolution 1000 from the list of candidates (i.e., an adaptive resolution) with regards to the BER loss threshold (e.g., an 1% BER limit). According to a numerical simulation over a plurality of different channel states, the resolution 1000 selected on average was 1/(12.3 PRB), which is significantly lower than the static (i.e., fixed or maximum) resolution of 1/(2 PRB). This shows that it is advantageous to select a resolution 1000 in the step 206, e.g., based on one or more QoS requirements.

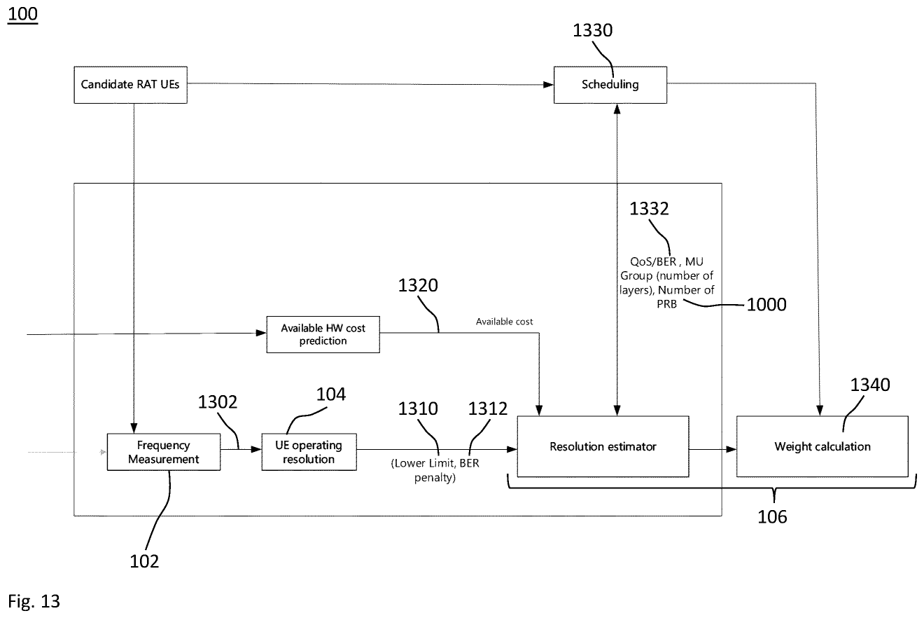

FIG. 13 schematically illustrates a block diagram of an embodiment of the device 100. The block diagram may provide a high-level overview of the embodiment.

Performing the channel estimation 202 in the module 102 may also be referred to as a measurement of a frequency response (or channel response function) of the radio channel as the channel state 1302. Alternatively or in addition, the step 202 may comprise a measurement of the coherence bandwidth 404 and/or a measurement of the delay spread of the radio channel. E.g. as presented in the dependency on the channel requirement above, it is possible to determine (e.g., estimate) an optimal resolution or a lower limit of the resolution 1000 based on the channel state, for example by analyzing the FCF 400 of the channel frequency response, H(f).

For example, the resolution 1000 may be selected and/or the lower limit for the resolution 1000 (e.g., an upper limit for the width n of the window of the computation 1340) may be determined based on a coherence bandwidth 404 of the radio channel and/or (e.g., the root mean square, RMS, of) the delay spread of the radio channel.

The channel state (e.g., the frequency response) resulting from the channel estimation 202 can therefore determine (e.g., estimate) the lowest resolution possible to use without significant increase of the BER 500. This lower limit as a result 1302 of the channel estimation may be sent to a resolution estimator (which may also be referred to as resolution selector), e.g., the module 106 and/or as input for the selection in the step 206. The lower limit 1302 may be used together with one or more other parameters in the module 106 and/or the step 206 for the selection of the resolution 1000. Alternatively or in addition, the lower limit may be sent to the module 104 so that the list of candidates comprises only resolutions that are greater than the lower limit.

The module 104 may be implemented by a UE operating resolution estimation (res_{UE}).

For concreteness and without limitation, the radio device 320 may be a UE.

This estimation may be performed for each UE 320 by a base station 310 performing the method 200 (i.e., embodying the device 100) and/or serving the UE 320. Using the channel state (e.g., the frequency response measurement) resulting from the step 202, the list of candidates for the resolution 1000 is determined (e.g. generated) in the step 204. The list may be implemented as a set of recommendations for the resolution 1000.

Each candidate in the list (e.g., each recommendation) contains at least one of following pieces of information.

A first piece of information is the candidate resolution 1310 (briefly: resolution), i.e., the candidate 1310 for the frequency domain resolution 1000 for the computation 1340 of the beamforming weights. The resolution 1000 may also be referred to as (e.g., UE) operating resolution. The resolution 1310 may be the recommended or selected resolution for the UE 320. Examples for the resolution comprise 1/(2 PRB), 1/(4 PRB), and wideband.

A second piece of information is the loss 1312 in terms of the BER 500, which may also be referred to BER loss or BER penalty. The BER penalty 1312 may be associated with the respective candidate (e.g., recommended) resolution 1310.

A third piece of information comprises the SINR. The candidate resolution 1310 may be recommended or selected for the SINR indicated in the list.

The UE operating resolution may be the lower limit of the resolution 1000, e.g., for a given UE and/or the channel state. A frequency domain resolution for the computation 1340 of the beamforming weights below this resolution may give a bad throughput performance. Multiple candidates 1310 (e.g., UE operating resolutions) are determined (e.g., generated) as a basis for the selection of the resolution 1000 in the sept 206. Preferably, each candidate (i.e., each recommendation) includes the BER penalty 1312 to assist maintaining a QoS (e.g., as requirement of the UE and/or the data) while selecting the resolution 1000 in the step 206.

The selected resolution 1000 may be transmitted from the device 100 (e.g., from the base station 310) to a peer of the beamformed transmission 206 or beamformed reception 206 (e.g., to a UE) in a control message. The control message may be a scheduling message, e.g., a DCI, when scheduling 1330 the peer or when being scheduled by the peer.

Alternatively or in addition, the control message may comprise the list of candidates as determined in the step 204. The list may be used by the peer for selecting the resolution 1000, which may be reported to the device 100 for performing the beamformed transmission 206 or beamformed reception 206.

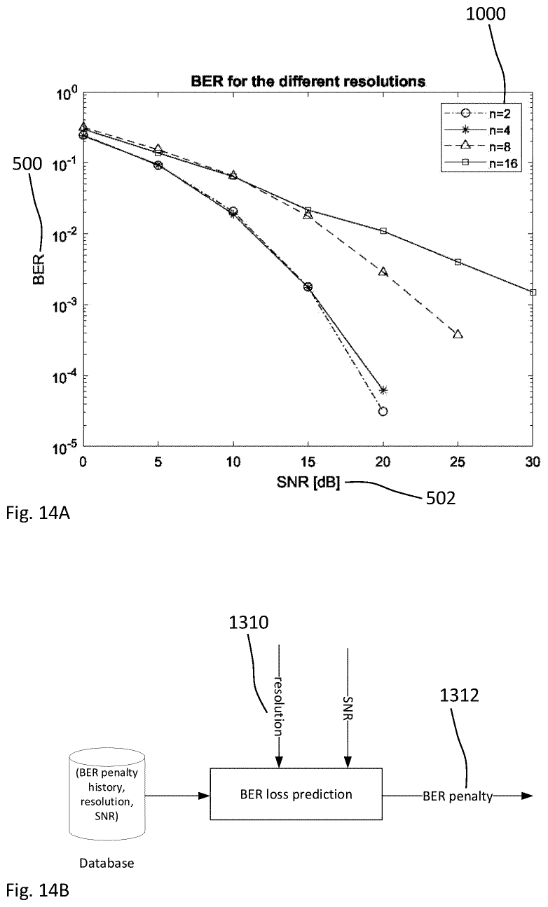

FIG. 14A schematically illustrates the BER 500 resulting from the computation 1340 of the beamforming weights with different frequency domain resolutions for determining the loss 1312 in terms of the BER 500 (i.e., the BER penalty 1312).

The BER penalty 1312 is an estimation of the increase of the BER 500 caused by selecting a candidate resolution 1310 that is less than the maximum resolution or less than the lower limit of the resolution 1000. The latter case means that the channel state (e.g., the analysis of the frequency response) in the step 202 has resulted in a lower limit (e.g., a recommendation) for a higher resolution. This is used when selecting a resolution for a group of UEs where not all UEs have the same recommended resolutions, or when the available hardware resources do not allow for the optimal resolution. The BER penalty 1312 is estimated from analysis of the frequency response.

In the example of the FIG. 14A, the recommended resolution is 1/(4 PRB), and the BER penalty 1312 for the resolution 1/(8 PRB) would be the difference between the two curves of the BER 500 corresponding to the inverse n=4 and n=8, respectively, of the resolution 1000.

The selection 206 of the resolution 1000 from the list of candidates and/or the determination 204 of the list of candidates may depend on a prediction of the available hardware (HW) resource (e.g., a HW load) for the beamforming 206 (avgHwBf_{bs}), e.g., for the computation 1340 of the beamforming weights.

The base station 310 as an example of. the device 100 has a limited HW resource and this needs to be shared across different processing within the base station 310. One such processing is the beamforming, e.g., the computation 1340 of the beamforming weights. Hence, the available HW resource for the beamforming processing depends on the HW usage for other baseband processing. The total HW resource usage, and hence the available HW resource for beamforming 206, will vary across time and/or depends hugely on the traffic situation and amount of data to process within the base station 310.

The selection of the resolution 1000 (which may also be referred to as beamforming operation resolution selection) may depend on the available HW resource for the beamforming 206. Hence, it is important to predict the available HW cost 1320 for the beamforming 206.

In any case, the HW resource usage cost should not exceed a HW resource usage limit, totalHwCostLimit_{bs}.

Early prediction of the available HW resource will help in better planning of the beamforming activity.

This can be done using the machine learning (ML) techniques. The HW usage statistics are monitored continuously, and a ML model is trained so that the HW usage can be predicted early in the slot (for a given traffic scenario).

The baseband HW resource cost for beamforming can be predicted using the ML regression as below,

$${requiredHwCost}_{bs} = {β}_{0} + {β}_{1} f ( totalDataInBuffer )$$

wherein,
β₀ & β₁ are tuning parameter used to fit the regression curve so that residual error is minimal
f(totalDataInBuffer) is the function of the amount of data in the buffer.

Once predictedHwCostNonBf_{bs} is predicted, the available HW cost for beamforming processing is calculated as below,

$${availableHwCostBf}_{bs} = {totalHwCostLimit}_{bs} - {predictedHwCostNonBf}_{bs}$$

The selection of the resolution may be implemented in a base station 310 as an example of the device 100 using a prediction of a (e.g., baseband) operating resolution (res_{bs}).

The baseband operating resolution depends on the amount of HW resources available for the beamforming. The amount of HW that is available will vary across time and depends hugely on the traffic situation and amount of data to process within the base station 310.

The baseband operating resolution estimation may give the recommendation (e.g., the selection in the step 206) for the best operating resolution for the base station 310, e.g., for a given slot or for each slot.

The HW usage statistics are monitored continuously, and resolution operating point is estimated and/or predicted so that HW usage does not exceed the maximum limit of the available HW resource.

The baseband operating resolution can be predicted using ML regression, e.g., as given below,

$${res}_{bs} = {β}_{0} + {β}_{1} f ( availHw , totalDataInBuffer ) ,$$

wherein:
β₀ & β₁ are tuning parameter used to fit the regression curve so that residual error is minimal, and/or
f(availHw, totalDataInBuffer) is the function of available hardware resource and the amount of data in the buffer.
The average operating resolution avgRes_{bs} per PRB is given by,

$${avgRes}_{bs} = \frac{{res}_{bs}}{BW} ,$$

wherein:
   res_{bs}=base station operating resolution
   BW=Operating Bandwidth in number of PRBs
   avgRes_{bs}=Average (per PRB) base station operating resolution

The module 106 for performing the step 206, particularly for the selection of the resolution may be implemented by a resolution estimator (also referred to as resolution selector).

The selection of the resolution 1000 (e.g., the resolution estimation) depends on a type of an allocation (e.g., including single-user, SU, or multi-user, MU) and/or a number of layers (e.g., spatial streams) that will be allocated (e.g., to the UE 320).

In any embodiment, the resolution 1000 may be selected in the step 206 depending on at least one or each of the following deciding parameters. The parameters may be needed to estimate the resolution 1000.

A first deciding parameter may be the available HW resources and/or the HW cost for the beamforming 206.

A second deciding parameter may be the list of candidates 1310 (e.g., the set of recommended UE operating resolutions) together with associated BER penalty (resᵤₑ) 1312.

A third deciding parameter is the allocation type. The allocation type may comprise at least one of the number of layers, the number of PRBs, and SU or MU.

Using the observation that different resolution cause different BER for a given SNR (e.g., as illustrated in FIG. 14A) and with the help statistical analysis (e.g., using a database as illustrated at the left-hand side of FIG. 14B), it is possible to predict the BER penalty 1312 for a given candidate resolution 1310 (optionally and the SNR or SNIR), e.g., using the BER loss prediction of FIG. 14B and/or below function:

$$BER\_Penalty = {α}_{0} + {α}_{1} f ( resolution , SNR , {T}_{RMS} )$$

wherein
BER_Penalty is the BER penalty 1312 for a candidate resolution 1310;
α₀ and α₁ are tuning parameters; and
f( ) is a function of the resolution, SINR and delay spread (T_{RMS}) of the channel.

More specifically, the resolution 1000 may be selected (e.g., estimator) for the radio channel configured for single user (SU) and multiple input-multiple output (MIMO), which is referred to as a SU-MIMO channel.

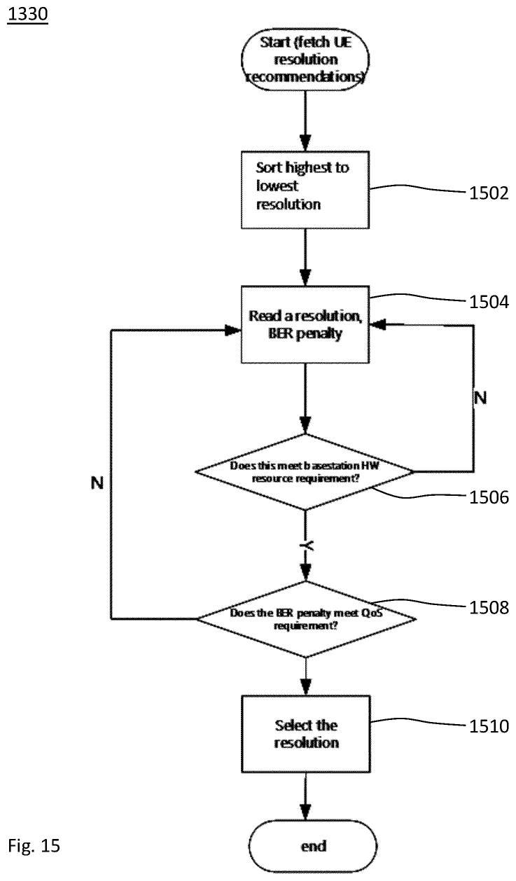

FIG. 15 shows a flowchart for the selection 1330 (e.g., the scheduling) of the resolution 1000. An implementation of the selection 1330 of the resolution 1000 for SU is shown in the flowchart of FIG. 15.

The lowest resolution that is greater than the lower limit for the resolution may be a starting point for selecting the resolution 1000 from the list of candidates. To this end, e.g., as indicated at reference sign 1502, the candidates may be sorted according to the candidate resolution. In the sorting 1502, “highest” and “lowest” may refer to the greatest and least value of n, i.e., the inverse of the resolution.

The sorted candidates may be read (e.g., at least one of the decisive parameters) in the step 1504.

A step 1506 verifies that the candidate fulfills the HW resource requirement, e.g., by iterating through the (e.g., sorted) list of candidates.

In order to compare the candidate resolution with the HW resource requirement, the candidate resolution may be converted to a value for the HW cost.

The conversion of the resolution to HW cost may be performed in the step 1506 using a per-PRB HW cost as a function of the number of layers and the resolution.

$${hwCost}_{group} = f ( layers , resolution )$$

wherein:
   hwCost_{group}=The HW resource cost per group per PRB, and f(layers, resolution) is a function that maps the number of layers and resolution to the HW cost. This function may be obtained by measuring the HW cost for pairs of a layer and a resolution.

The hwCost_{group} is compared with per-PRB available HW cost and the resolution is selected for further processing if

$${hwCost}_{group} < 1 / BW ( {availableHwCostBf}_{bs} ) ,$$

wherein BW is the bandwidth size in PRBs.

In a step 1508, the candidate resolution that passed through the HW cost requirement in the step 1506 is checked for a requirement for the BER 500 and/or a QoS (e.g., which may correspond to a upper limit of the BER). If the BER requirement is satisfied, then the candidate resolution is the selected resolution 1000 in the step 206.

The step 206 may comprise the computation 1350 of the beamforming weights using the selected resolution 1000.

With the channel matrix down-sampled from symbol to PRB level, the beamforming weights that minimize a mean square error (MMSE) for a specific PRB can be calculated as

$$W = {{H}^{H} ( {HH}^{H} + α I )}^{- 1} ,$$

wherein α depends on the noise variation of the channel, H is the channel matrix (e.g., the channel response function at the corresponding frequency f) and I is the identity matrix. The transmitted symbol (e.g., a reference symbol) will then be

$$y = Wx ,$$

wherein x is the complex symbol to be transmitted.

If the weights Ware calculated for one PRB, the same weights are then used to weigh all symbols in the current PRB and the adjacent or following n−1 PRBs, wherein n is the inverse of the resolution 1000, e.g., a value given by the resolution estimator implementing the module 106. This reduces the overall weight computation time by a factor of 1/n.

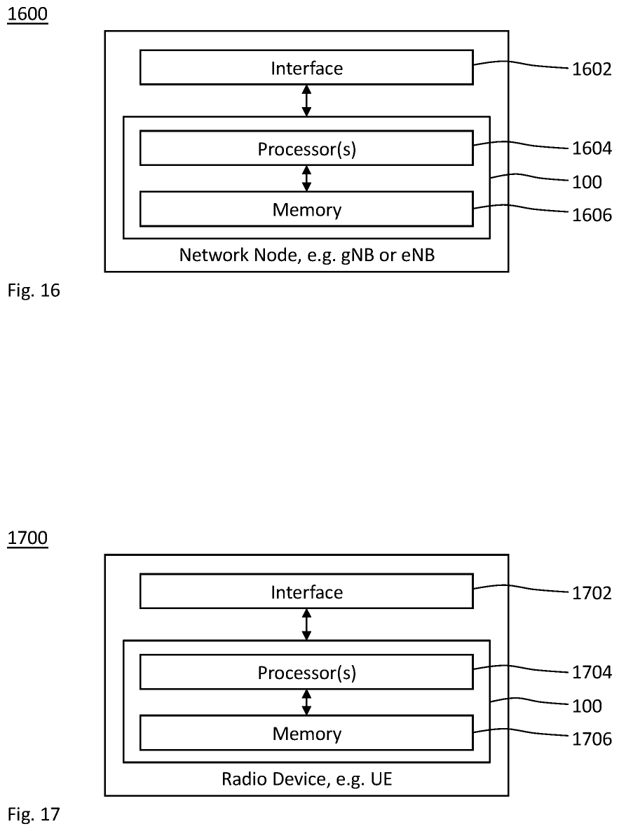

FIG. 16 shows a schematic block diagram for an embodiment of the device 100. The device 100 comprises processing circuitry, e.g., one or more processors 1604 for performing the method 200 and memory 1606 coupled to the processors 1604. For example, the memory 1606 may be encoded with instructions that implement at least one of the modules 102, 104 and 106.

The one or more processors 1604 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1606, transmitter or receiver functionality. For example, the one or more processors 1604 may execute instructions stored in the memory 1606. Such functionality may include providing various features and steps discussed herein, including any of the benefits disclosed herein. The expression “the device being operative to perform an action” may denote the device 100 being configured to perform the action.

As schematically illustrated in FIG. 16, the device 100 may be embodied by a base station 1600, e.g., functioning as a network node of a RAN. The base station 1600 comprises a radio interface 1602 coupled to the device 100 for radio communication with one or more UEs.

FIG. 17 shows a schematic block diagram for an embodiment of the device 100. The device 100 comprises processing circuitry, e.g., one or more processors 1704 for performing the method 200 and memory 1706 coupled to the processors 1704. For example, the memory 1706 may be encoded with instructions that implement at least one of the modules 102, 104 and 106.

The one or more processors 1704 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1706, transmitter or receiver functionality. For example, the one or more processors 1704 may execute instructions stored in the memory 1706. Such functionality may include providing various features and steps discussed herein, including any of the benefits disclosed herein. The expression “the device being operative to perform an action” may denote the device 200 being configured to perform the action.

As schematically illustrated in FIG. 17, the device 100 may be embodied by a radio device 1700, e.g., functioning as a UE. The radio device 1700 comprises a radio interface 1702 coupled to the device 100 for radio communication with one or more base stations, e.g., functioning as a network node of a RAN.

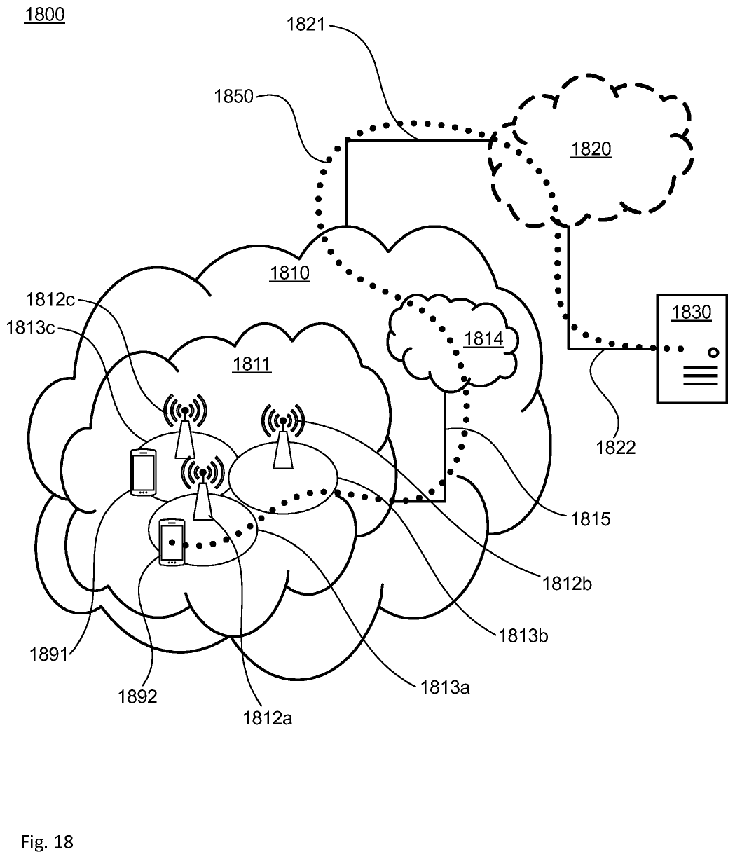

With reference to FIG. 18, in accordance with an embodiment, a communication system 1800 includes a telecommunication network 1810, such as a 3GPP-type cellular network, which comprises an access network 1811, such as a radio access network, and a core network 1814. The access network 1811 comprises a plurality of base stations 1812a, 1812b, 1812c, such as NBs, eNBs, gNBs or other types of wireless access points, each defining a corresponding coverage area 1813a, 1813b, 1813c. Each base station 1812a, 1812b, 1812c is connectable to the core network 1814 over a wired or wireless connection 1815. A first user equipment (UE) 1891 located in coverage area 1813c is configured to wirelessly connect to, or be paged by, the corresponding base station 1812c. A second UE 1892 in coverage area 1813a is wirelessly connectable to the corresponding base station 1812a. While a plurality of UEs 1891, 1892 are illustrated in this example, the disclosed embodiments are equally applicable to a situation where a sole UE is in the coverage area or where a sole UE is connecting to the corresponding base station 1812.

Any of the base stations 1812 and the UEs 1891, 1892 may embody the device 100.

The telecommunication network 1810 is itself connected to a host computer 1830, which may be embodied in the hardware and/or software of a standalone server, a cloud-implemented server, a distributed server or as processing resources in a server farm. The host computer 1830 may be under the ownership or control of a service provider, or may be operated by the service provider or on behalf of the service provider. The connections 1821, 1822 between the telecommunication network 1810 and the host computer 1830 may extend directly from the core network 1814 to the host computer 1830 or may go via an optional intermediate network 1820. The intermediate network 1820 may be one of, or a combination of more than one of, a public, private or hosted network; the intermediate network 1820, if any, may be a backbone network or the Internet; in particular, the intermediate network 1820 may comprise two or more sub-networks (not shown).

The communication system 1800 of FIG. 18 as a whole enables connectivity between one of the connected UEs 1891, 1892 and the host computer 1830. The connectivity may be described as an over-the-top (OTT) connection 1850. The host computer 1830 and the connected UEs 1891, 1892 are configured to communicate data and/or signaling via the OTT connection 1850, using the access network 1811, the core network 1814, any intermediate network 1820 and possible further infrastructure (not shown) as intermediaries. The OTT connection 1850 may be transparent in the sense that the participating communication devices through which the OTT connection 1850 passes are unaware of routing of uplink and downlink communications. For example, a base station 1812 need not be informed about the past routing of an incoming downlink communication with data originating from a host computer 1830 to be forwarded (e.g., handed over) to a connected UE 1891. Similarly, the base station 1812 need not be aware of the future routing of an outgoing uplink communication originating from the UE 1891 towards the host computer 1830.

By virtue of the method 200 being performed by any one of the UEs 1891 or 1892 and/or any one of the base stations 1812, the performance or range of the OTT connection 1850 can be improved, e.g., in terms of increased throughput and/or reduced latency. More specifically, the host computer 1830 may indicate to the RAN 300 or the radio device 100 or the base station 100 (e.g., on an application layer) the QoS of the traffic.

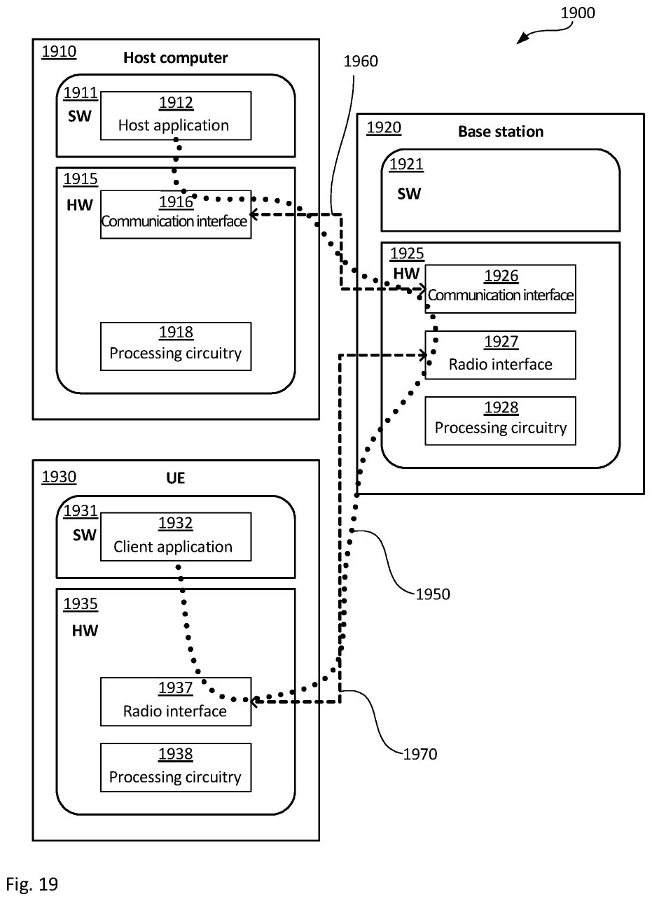

Example implementations, in accordance with an embodiment of the UE, base station and host computer discussed in the preceding paragraphs, will now be described with reference to FIG. 19. In a communication system 1900, a host computer 1910 comprises hardware 1915 including a communication interface 1916 configured to set up and maintain a wired or wireless connection with an interface of a different communication device of the communication system 1900. The host computer 1910 further comprises processing circuitry 1918, which may have storage and/or processing capabilities. In particular, the processing circuitry 1918 may comprise one or more programmable processors, application-specific integrated circuits, field programmable gate arrays or combinations of these (not shown) adapted to execute instructions. The host computer 1910 further comprises software 1911, which is stored in or accessible by the host computer 1910 and executable by the processing circuitry 1918. The software 1911 includes a host application 1912. The host application 1912 may be operable to provide a service to a remote user, such as a UE 1930 connecting via an OTT connection 1950 terminating at the UE 1930 and the host computer 1910. In providing the service to the remote user, the host application 1912 may provide user data, which is transmitted using the OTT connection 1950. The user data may depend on the location of the UE 1930. The user data may comprise auxiliary information or precision advertisements (also: ads) delivered to the UE 1930. The location may be reported by the UE 1930 to the host computer, e.g., using the OTT connection 1950, and/or by the base station 1920, e.g., using a connection 1960.

The communication system 1900 further includes a base station 1920 provided in a telecommunication system and comprising hardware 1925 enabling it to communicate with the host computer 1910 and with the UE 1930. The hardware 1925 may include a communication interface 1926 for setting up and maintaining a wired or wireless connection with an interface of a different communication device of the communication system 1900, as well as a radio interface 1927 for setting up and maintaining at least a wireless connection 1970 with a UE 1930 located in a coverage area (not shown in FIG. 19) served by the base station 1920. The communication interface 1926 may be configured to facilitate a connection 1960 to the host computer 1910. The connection 1960 may be direct, or it may pass through a core network (not shown in FIG. 19) of the telecommunication system and/or through one or more intermediate networks outside the telecommunication system. In the embodiment shown, the hardware 1925 of the base station 1920 further includes processing circuitry 1928, which may comprise one or more programmable processors, application-specific integrated circuits, field programmable gate arrays or combinations of these (not shown) adapted to execute instructions. The base station 1920 further has software 1921 stored internally or accessible via an external connection.

The communication system 1900 further includes the UE 1930 already referred to. Its hardware 1935 may include a radio interface 1937 configured to set up and maintain a wireless connection 1970 with a base station serving a coverage area in which the UE 1930 is currently located. The hardware 1935 of the UE 1930 further includes processing circuitry 1938, which may comprise one or more programmable processors, application-specific integrated circuits, field programmable gate arrays or combinations of these (not shown) adapted to execute instructions. The UE 1930 further comprises software 1931, which is stored in or accessible by the UE 1930 and executable by the processing circuitry 1938. The software 1931 includes a client application 1932. The client application 1932 may be operable to provide a service to a human or non-human user via the UE 1930, with the support of the host computer 1910. In the host computer 1910, an executing host application 1912 may communicate with the executing client application 1932 via the OTT connection 1950 terminating at the UE 1930 and the host computer 1910. In providing the service to the user, the client application 1932 may receive request data from the host application 1912 and provide user data in response to the request data. The OTT connection 1950 may transfer both the request data and the user data. The client application 1932 may interact with the user to generate the user data that it provides.

It is noted that the host computer 1910, base station 1920 and UE 1930 illustrated in FIG. 19 may be identical to the host computer 1830, one of the base stations 1812a, 1812b, 1812c and one of the UEs 1891, 1892 of FIG. 18, respectively. This is to say, the inner workings of these entities may be as shown in FIG. 19, and, independently, the surrounding network topology may be that of FIG. 18.

In FIG. 19, the OTT connection 1950 has been drawn abstractly to illustrate the communication between the host computer 1910 and the UE 1930 via the base station 1920, without explicit reference to any intermediary devices and the precise routing of messages via these devices. Network infrastructure may determine the routing, which it may be configured to hide from the UE 1930 or from the service provider operating the host computer 1910, or both. While the OTT connection 1950 is active, the network infrastructure may further take decisions by which it dynamically changes the routing (e.g., on the basis of load balancing consideration or reconfiguration of the network).

The wireless connection 1970 between the UE 1930 and the base station 1920 is in accordance with the teachings of the embodiments described throughout this disclosure. One or more of the various embodiments improve the performance of OTT services provided to the UE 1930 using the OTT connection 1950, in which the wireless connection 1970 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1950 between the host computer 1910 and UE 1930, in response to variations in the measurement results. The measurement procedure and/or the network functionality for reconfiguring the OTT connection 1950 may be implemented in the software 1911 of the host computer 1910 or in the software 1931 of the UE 1930, or both. In embodiments, sensors (not shown) may be deployed in or in association with communication devices through which the OTT connection 1950 passes; the sensors may participate in the measurement procedure by supplying values of the monitored quantities exemplified above, or supplying values of other physical quantities from which software 1911, 1931 may compute or estimate the monitored quantities. The reconfiguring of the OTT connection 1950 may include message format, retransmission settings, preferred routing etc.; the reconfiguring need not affect the base station 1920, and it may be unknown or imperceptible to the base station 1920. Such procedures and functionalities may be known and practiced in the art. In certain embodiments, measurements may involve proprietary UE signaling facilitating the host computer's 1910 measurements of throughput, propagation times, latency and the like. The measurements may be implemented in that the software 1911, 1931 causes messages to be transmitted, in particular empty or “dummy” messages, using the OTT connection 1950 while it monitors propagation times, errors etc.

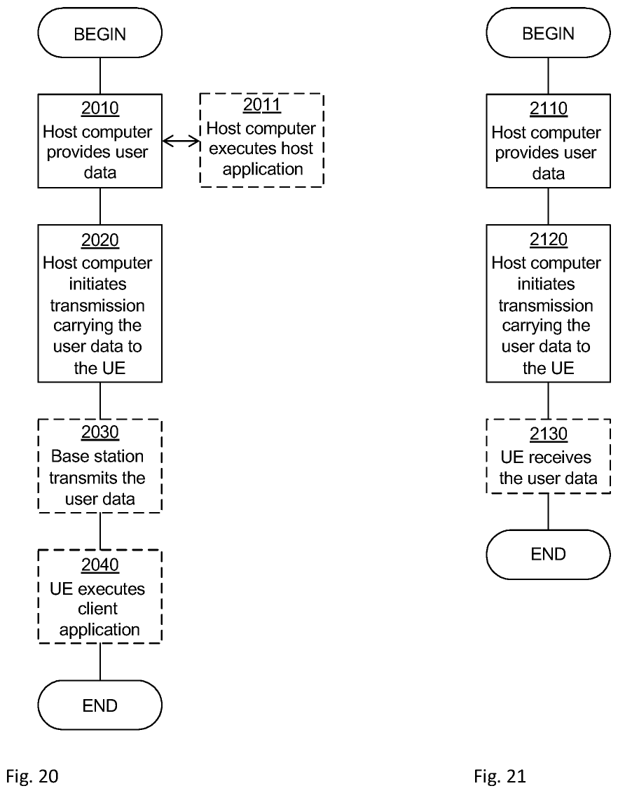

FIG. 20 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 20 will be included in this paragraph. In a first step 2010 of the method, the host computer provides user data. In an optional substep 2011 of the first step 2010, the host computer provides the user data by executing a host application. In a second step 2020, the host computer initiates a transmission carrying the user data to the UE. In an optional third step 2030, the base station transmits to the UE the user data which was carried in the transmission that the host computer initiated, in accordance with the teachings of the embodiments described throughout this disclosure. In an optional fourth step 2040, the UE executes a client application associated with the host application executed by the host computer.

FIG. 21 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 21 will be included in this paragraph. In a first step 2110 of the method, the host computer provides user data. In an optional substep (not shown) the host computer provides the user data by executing a host application. In a second step 2120, the host computer initiates a transmission carrying the user data to the UE. The transmission may pass via the base station, in accordance with the teachings of the embodiments described throughout this disclosure. In an optional third step 2130, the UE receives the user data carried in the transmission.

As has become apparent from above description, at least some embodiments of the technique allow a device (e.g., a base station) for beamforming to selection the best possible beamforming resolution for a given HW load scenario, channel response and QoS (e.g., required by a UE). Same or further embodiments can achieve savings in HW resources of the device (e.g., a base station) for beamforming. Same or further embodiments can increase a cell capacity of a RAN. Same or further embodiments achieve power savings due to channel equalization (for demodulation) only for the needed frequencies (e.g., at the UE side). Same of further embodiments can avoid selecting a high resolution in the frequency domain if such a resolution not needed.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method of performing at least one of a beamformed transmission and a beamformed reception on a radio channel, the method comprising:
performing a channel estimation of the radio channel, a result of the channel estimation being indicative of a channel state of the radio channel;
determining a list of candidates for a frequency domain resolution of beamforming weights, each of the candidates being associated with a loss in terms of a bit error rate, BER, depending on the channel state of the radio channel; and
performing at least one of the beamformed transmission and the beamformed reception using the beamforming weights computed based on the channel state of the radio channel, wherein
the frequency domain resolution for the computation of the beamforming weights is selected from the list of candidates depending on the associated loss in terms of the BER.

2. The method of claim 1, wherein the list of candidates comprises a first candidate and a second candidate, the frequency domain resolution of the first candidate being greater than the frequency domain resolution of the second candidate,
wherein a computational complexity for the computation of the beamforming weights is greater for the first candidate than the second candidate, and/or the loss in terms of the BER associated with the first candidate is less than the loss in terms of the BER associated with the second candidate, and/or wherein a statistical error of the computation of the beamforming weights is greater or less for the first candidate than the second candidate.

3. The method of claim 1, wherein the least frequency domain resolution is selected among the candidates associated with a loss in terms of the BER that is equal to or less than a predefined BER loss threshold.

4. The method of claim 3, wherein the predefined BER loss threshold corresponds to or depends on a quality of service, QoS, associated with data to be at least one of transmitted in the beamformed transmission and received in the beamformed reception.

5. The method of claim 1, wherein the greatest frequency domain resolution is selected among the candidates associated with a computational complexity that is equal to or less than a computational complexity threshold.

6. The method of claim 5, wherein the computational complexity threshold depends on a current hardware load or a predicted hardware cost at a transmitter of the beamformed transmission or a receiver of the beamformed reception.

7. The method of claim 1, wherein the loss in terms of the BER depending on the channel state of the radio channel defines a lower limit on the frequency domain resolution, and
wherein at least one of
the determination includes only candidates for the frequency domain resolution in the list that are greater than the lower limit; and
the resolution selected from the list is greater than the lower limit.

8. The method of claim 1, wherein a current hardware load or a predicted hardware cost at a transmitter of the beamformed transmission or a receiver of the beamformed reception defines an upper limit on the frequency domain resolution, and
wherein at least one of
the determination includes only candidates for the frequency domain resolution in the list that are less than the upper limit; and
the resolution selected from the list is less than the upper limit.

9. The method of claim 8, wherein the frequency domain resolution is selected among the candidates between the upper limit and the lower limit, optionally according to a predefined BER loss threshold that corresponds to a QoS associated with data to be at least one of transmitted in the beamformed transmission and received in the beamformed reception.

10. The method of claim 1, wherein the method is performed by a base station of a radio access network, RAN, and
wherein the beamformed transmission uses a downlink on the radio channel from the base station to a radio device, or the beamformed reception uses an uplink on the radio channel from a radio device to the base station.

11. The method of claim 1, wherein the method is performed by a radio device connected or connectable to a base station of a RAN, and
wherein the beamformed transmission uses an uplink on the radio channel to the base station serving the radio device, or the beamformed reception uses a downlink on the radio channel from the base station serving the radio device.

12. The method of claim 1, wherein the determining of the list of candidates comprises transmitting a control message to a receiver of the beamformed transmission or to a transmitter of the beamformed reception,
the control message being indicative of the list of candidates for the frequency domain resolution of the beamforming weights and the loss in terms of the BER associated with each of the candidates, or the control message being indicative of the selected frequency domain resolution.

13. The method of claim 1, wherein the determining of the list of candidates comprises receiving a control message from a receiver of the beamformed transmission or from a transmitter of the beamformed reception,
the control message being indicative of the list of candidates for the frequency domain resolution of the beamforming weights and the loss in terms of the BER associated with each of the candidates, or the control message being indicative of the selected frequency domain resolution.

14. The method of claim 1, wherein the performing of at least one of the beamformed transmission and the beamformed reception comprises transmitting a control message to a receiver of the beamformed transmission or to a transmitter of the beamformed reception,
the control message being indicative of the selected frequency domain resolution.

15. The method of claim 1, wherein the performing of at least one of the beamformed transmission and the beamformed reception comprises receiving a control message from a receiver of the beamformed transmission or from a transmitter of the beamformed reception,
the control message being indicative of the selected frequency domain resolution.

16. The method of claim 1, wherein the beamforming weights are computed for frequency domain windows, respectively,
a width of each of the frequency domain windows being inversely proportional to the frequency domain resolution for the computation of the beamforming weights.

17. The method of claim 1, wherein the channel estimation is based on reference signals that are spaced apart in the frequency domain of the radio channel, and wherein the beamforming weights are computed for frequency domain windows based on the reference signals in the respective frequency domain window.

18. The method of claim 1, wherein the computation of the beamforming weights applies an averaging filter in the frequency domain, wherein a width of the averaging filter is inversely proportional to the frequency domain resolution.

19. The method of claim 1, wherein the losses of the BER associated with the candidates of the frequency domain resolution in the list are computed based on at least one of the channel state of the radio channel, a frequency correlation function of the channel state, a width of a frequency correlation function of the channel state, and a delay spread of the radio channel.

20. The method of claim 1, wherein the inverse of the frequency domain resolution corresponds to an integer multiple of a physical resource block, PRB, optionally to an even multiple of a PRB or to a power of two of a PRB.

21-25. (canceled)

26. A user equipment (UE) for performing at least one of a beamformed transmission and a beamformed reception on a radio channel, the UE configured to communicate with a base station or with a radio device functioning as a gateway, the UE comprising a radio interface and processing circuitry configured to:
perform a channel estimation of the radio channel, a result of the channel estimation being indicative of a channel state of the radio channel;
determine a list of candidates for a frequency domain resolution of beamforming weights, each of the candidates being associated with a loss in terms of a bit error rate, BER, depending on the channel state of the radio channel; and
perform at least one of the beamformed transmission and the beamformed reception using the beamforming weights computed based on the channel state of the radio channel, wherein the frequency domain resolution for the computation of the beamforming weights is selected from the list of candidates depending on the associated loss in terms of the BER.

27. (canceled)

28. A base station for performing at least one of a beamformed transmission and a beamformed reception on a radio channel, the base station comprising memory operable to store instructions and processing circuitry operable to execute the instructions, such that the base station is operable to:
perform a channel estimation of the radio channel, a result of the channel estimation being indicative of a channel state of the radio channel;
determine a list of candidates for a frequency domain resolution of beamforming weights, each of the candidates being associated with a loss in terms of a bit error rate, BER, depending on the channel state of the radio channel; and
perform at least one of the beamformed transmission and the beamformed reception using the beamforming weights computed based on the channel state of the radio channel, wherein the frequency domain resolution for the computation of the beamforming weights is selected from the list of candidates depending on the associated loss in terms of the BER.

29-38. (canceled)
